(19) United States
(12) Patent Application Publication
(10) Pub. No.: US 2007/0027817 A1
(43) Pub. Date: Feb. 1, 2007

(54) IC card, receiving apparatus, terminal list generating apparatus and terminal authentication method

(75) Inventors: Atsushi Hirota, Yokohama-shi (JP); Osamu Yoshida, Kawasaki-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/487,511

(22) Filed: Jul. 17, 2006

(30) Foreign Application Priority Data
Jul. 28, 2005 (JP) 2005-219204

(51) Int. Cl. G06Q 99/00

(52) U.S. Cl. 705/65

(57) ABSTRACT

An IC card includes a data receiving unit which receives a terminal authentication list and a receiving apparatus ID from a memory unit of a receiving apparatus, a first determination unit which obtains a first determination result by determining, with reference to first discrimination information, whether the terminal authentication list is an invalid terminal list or a valid terminal list, a second determination unit which obtains a second determination result by determining whether the receiving apparatus ID is included in the terminal authentication list, and a reply unit which returns to the receiving apparatus a response signal indicative of whether the receiving apparatus is the valid terminal or not, in accordance with contents of the first determination result and the second determination result.

### CROSS-REFERENCE TO RELATED APPLICATIONS

This application is based upon and claims the benefit of priority from Japanese Patent Application No. 2005-219204, filed Jul. 28, 2005, the entire contents of which are incorporated herein by reference.

### BACKGROUND

1. Field

One embodiment of the invention relates to an IC card, a receiving apparatus, a terminal list generating apparatus and a terminal authentication method. In particular, the invention is effectively applicable to a digital broadcast receiving apparatus which receives digital broadcast, and a receiver which performs content viewing/listening over a communication network.

2. Description of the Related Art

In recent years, satellite digital broadcasting using communications satellites and broadcast satellites and terrestrial digital broadcasting have been implemented. In the satellite digital broadcasting, pay broadcasting is adopted, and restrictive receiving systems, which enable viewing/listening control by various methods such as a channel-by-channel based method, a program-by-program based method and a time-based method, have been practiced (see, e.g. Japanese Patent No. 2,941,398).

In the restrictive receiving system, individual contract information based on, e.g. the current state of a contract with a user, is sent to a receiving apparatus and is set in the receiving apparatus or in an IC card that is inserted in use in the receiving apparatus.

In the description below, to set individual contract information in the receiving apparatus also means a case where individual contract information is set in a security module such as an IC card. The individual viewing/listening contract information, which is transmitted to each receiving apparatus, is called EMM (Entitlement Management Message) data.

An ID (Identification) number, which is uniquely assigned to the receiving apparatus, is added to the EMM data.

The EMM data is first encrypted by a master key (Km) which is uniquely assigned to the ID of the receiving apparatus, and then the encrypted EMM data is multiplexed on a broadcast signal and transmitted from the center apparatus of a broadcast station to each receiving apparatus.

On the other hand, content, such as video, audio and data, is scrambled by a scramble key (Ks), and then the scrambled content is multiplexed on the broadcast signal and transmitted from the center apparatus of the broadcast station to each receiving apparatus.

The scramble key (Ks) is encrypted by a work key (Kw) that is transmitted as part of the EMM data, and then the encrypted scramble key (Ks) is multiplexed on the broadcast signal and transmitted from the center apparatus of the broadcast station to each receiving apparatus.

At present, domestic digital broadcasting is practiced according to ARIB-STD B25 standard. The above-described triple-key structure using ECM and EMM is adopted. The encryption method, which is used here, is a common key encryption method. The sender and receiver of information share the same key, thereby transmitting/receiving encrypted information.

Next, a description is given of the transmission/reception of information between a key management center which issues and manages an IC card, a broadcast station which transmits broadcast, a receiver which receives broadcast, and an IC card which is connected to the receiver.

The key management center issues an IC card by embedding a unique ID and a master key (Km) in the IC card. In order to view/listen to a program on the receiver to which the issued IC card is connected, a contract is made between the receiver and the broadcast station. There are several methods of the contract. For example, the user makes a request for viewing/listening of a program to the broadcast station on paper or by telephone.

If the contract of program viewing/listening is concluded, the broadcast station requests the key management center to encrypt an EMM including a work key (Kw) by a master key (Km) of the IC card that is issued. The broadcast station delivers the EMM, which is encrypted by the master key (Km), to the receiver by broadcasting.

The receiver, which has received the EMM, sends the EMM to the IC card. In the IC card, the EMM is decrypted by the master key (Km) that is set in the IC card, and a work key (Kw) is extracted and stored in the memory.

At the time of program viewing/listening, the receiver sends the ECM, which is acquired through broadcast, to the IC card. In the IC card, the ECM is decrypted by the work key (Kw) to extract the scramble key (Ks), and the scramble key (Ks) is returned to the receiver. The receiver decrypts content using the scramble key (Ks).

In general, in the authentication process, a terminal authentication list, which is called “revoke list”, is issued from a key management organization, and the revoke list is distributed and used through a provider. An example of the revoke list is RFC3280 X509.2 (Internet X.509 Public Key Infrastructure Certificate and Certificate Revocation List Profile version 2). The revoke list executes an authentication process within a security module such as an IC card, and controls reception/delivery of a decryption key such as the scramble key (Ks) on the basis of the result of the authentication process.

An object of the present invention is to provide a terminal authentication system and a terminal authentication apparatus which can facilitate distribution of a revoke list and can reduce an authentication process load in a security module such as an IC card. Another object of the invention is to provide an IC card, a receiving apparatus, a terminal list generating apparatus and a terminal authentication method, which can realize smooth and quick exclusion of an unlawful receiver.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram of the structure of a digital broadcast receiving apparatus according to a first embodiment;

FIG. 2 illustrates an authentication sequence according to the first embodiment;

FIG. 3 is a flow chart illustrating a process that is executed by a receiver according to the first embodiment;

FIG. 4 is a flow chart illustrating a process that is executed by an IC card according to the first embodiment;

FIG. 5 is an explanatory view showing the outline of the data structure of a terminal authentication list according to the first embodiment;

FIG. 6 is a flow chart illustrating a process that is executed by the IC card according to the first embodiment, illustrating step S406 in FIG. 4 in greater detail;

FIG. 7 is an explanatory view showing the outline of the data structure of a terminal authentication list according to a second embodiment;

FIG. 8 is a flow chart illustrating a process that is executed by an IC card according to the second embodiment;

FIG. 9 is an explanatory view showing an example of the data structure of a terminal authentication list in a third embodiment of the invention; and

FIG. 10 is an explanatory view showing an example of a generation unit which generates a terminal authentication list in a server.

### DETAILED DESCRIPTION

Various embodiments according to the invention will be described hereinafter with reference to the accompanying drawings. In general, according to one embodiment of the invention, an IC card comprises a data receiving unit which receives a terminal authentication list and a receiving apparatus ID from a memory unit of a receiving apparatus, a first determination unit which obtains a first determination result by determining, with reference to first discrimination information, whether the terminal authentication list is an invalid terminal list or a valid terminal list, a second determination unit which obtains a second determination result by determining whether the receiving apparatus ID is included in the terminal authentication list, and a reply unit which returns to the receiving apparatus a response signal indicative of whether the receiving apparatus is the valid terminal or not, in accordance with contents of the first determination result and the second determination result.

Embodiments of the present invention will now be described with reference to the accompanying drawings.

### First Embodiment

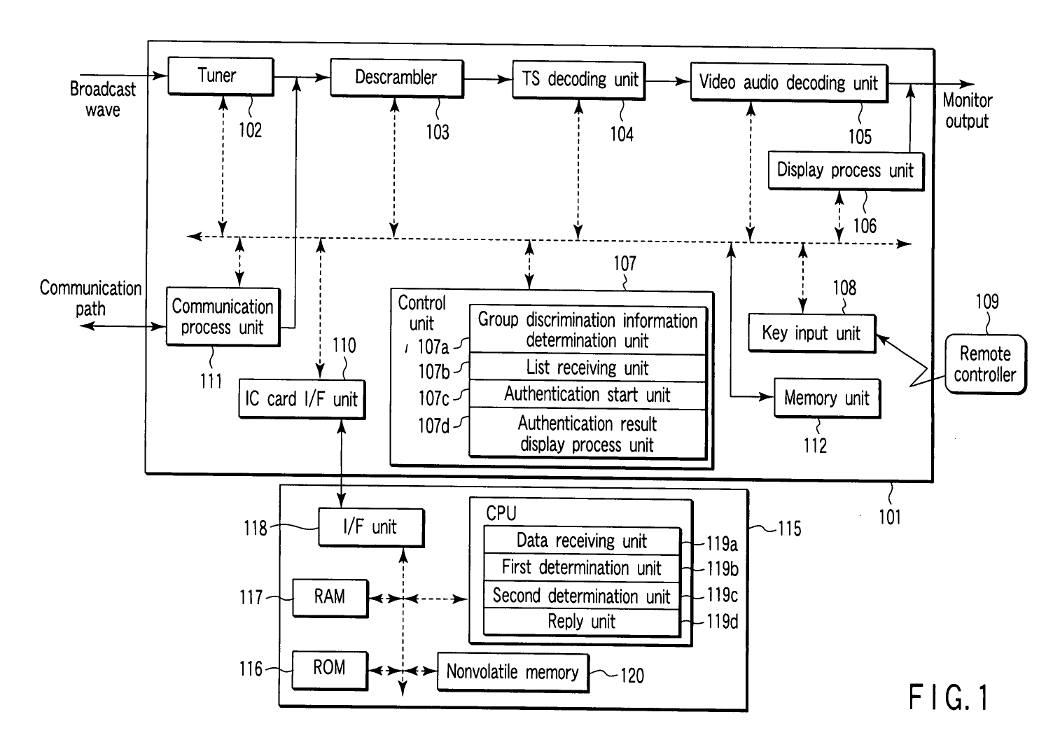

FIG. 1 is a block diagram showing the structure of a receiving apparatus according to an embodiment of the invention. In this embodiment, it is assumed that content is received via broadcasting. The invention is not limited to this embodiment. The invention is also applicable to cases where content is received via a communication network or a cable.

In FIG. 1, a digital broadcast receiving apparatus 101 comprises a tuner unit 102, a descrambler 103, a TS decoding unit 104, a video audio decoding unit 105, a display process unit 106, a control unit 107, a key input unit 108, an IC card I/F unit 110, a memory unit 112, and a communication process unit 111.

The tuner unit 102 selects a desired channel from broadcast waves that are input to the digital broadcast receiving apparatus 101, and outputs a transport stream (TS) of the selected channel to the descrambler 103. The TS is scrambled for content protection.

The descrambler 103 descrambles the TS which is input from the tuner unit 102, and outputs the descrambled TS to the TS decoding unit 104.

The TS decoding unit 104 separates necessary packets from the TS, which is input from the descrambler 103, on the basis of PSI (Program Specific Information), and further extracts a broadcast program signal (video, audio) from the separated packets or separates various multiplexed data (various SI (Service Information) data, ECM, EMM, etc.) from the separated packets. Moreover, the TS decoding unit 104 outputs the separated broadcast program signal (video, audio) to the video audio decoding unit 105.

The video audio decoding unit 105 decodes the broadcast program signal (video, audio) that is input from the TS decoding unit 104, and outputs the decoded signal to the display process unit 106.

The display process unit 106 outputs the broadcast program signal (video, audio), which is input from the video audio decoding unit 105, to an external monitor (not shown), and executes display/audio reproduction of the broadcast program signal. Further, the display process unit 106 has a function of generating display image signals of various error information in order to implement an interface function with the user, and outputting the generated image signal, instead of the broadcast program signal (video, audio), or mixing and outputting the generated image signal and the broadcast program signal (video, audio). In addition, the display process unit 106 has a function of generating an EPG (Electric Program Guide) image signal which is composed of SI data that is separated by the TS decoding unit 104, and outputting the generated image signal, instead of the broadcast program signal (video, audio), or mixing and outputting the generated image signal and the broadcast program signal (video, audio).

The key input unit 108 has a function of receiving a remote control signal, such as infrared, from a user interface device such as a remote controller 109.

The memory unit 112 is composed of a RAM and a nonvolatile memory. At least a terminal ID of the receiving apparatus, which is issued from the key management organization, is set in the nonvolatile memory when the digital broadcast receiving apparatus 101 is manufactured.

The communication process unit 111 is connected to a network line such as Ethernet™, and executes transmission/reception of data via the network. The communication process unit 111 has a function of receiving content from a server of a content provider and receiving ECM and EMM, and a function of acquiring a terminal ID list (terminal authentication list) of the receiving apparatus. The acquired terminal authentication list is stored in the memory unit 112.

The terminal authentication list is acquired from the receiving unit that has received broadcast waves, or acquired from the server via the communication process unit. The terminal authentication list is not necessarily acquired from the server.

The control unit 107 has a function of executing an overall control of the above-described functions. The control unit 107 controls the respective functions via bus connection, serial communication connection, etc.

The IC card I/F unit 110 is an IC card interface that supports ISO7816 which is an ISO standard.

An IC card 115 executes contract management and viewing/listening control. The IC card 115 comprises a CPU 119, a ROM 116, a RAM 117, a nonvolatile memory 120, and an I/F unit 118. The IC card 115 is connected to the digital broadcast receiving apparatus 101 via an interface that supports ISO7816 which is an ISO standard. At least a card ID and a unique key of the card are preset in the nonvolatile memory 120 within the IC card 115.

The control unit 107 outputs the EMM and ECM, which are separated from the TS by the TS decoding unit 104, to the IC card 115 via the IC card I/F unit 110.

When the EMM is input from the IC card I/F unit 110 to the IC card 115, the IC card 115 decrypts the EMM using the key unique to the card and stores information, which is acquired by the contract, such as a work key (Kw), in the nonvolatile memory 120 within the IC card 115. In addition, when the ECM is input from the IC card I/F 110 to the IC card 115, the IC card 115 decrypts the ECM using the work key (Kw) stored in the nonvolatile memory 120 within the IC card 115, and determines whether program viewing/listening is enabled or not. If the program viewing/listening is enabled, the IC card 115 outputs the scramble key (Ks) for descrambling to the digital broadcast receiving apparatus 101.

In the digital broadcast receiving apparatus 101, the control unit 107 sets the scramble key (Ks), which is input from the IC card 115, into the descrambler 103. Thereby, the descrambler 103 descrambles content and enables program viewing/listening.

Next, the operation of the receiving apparatus having the above-described structure is described in detail with reference to the drawings. In the present invention, the digital broadcast receiving apparatus 101 and IC card 115 execute authentication.

(Normal Authentication Sequence)

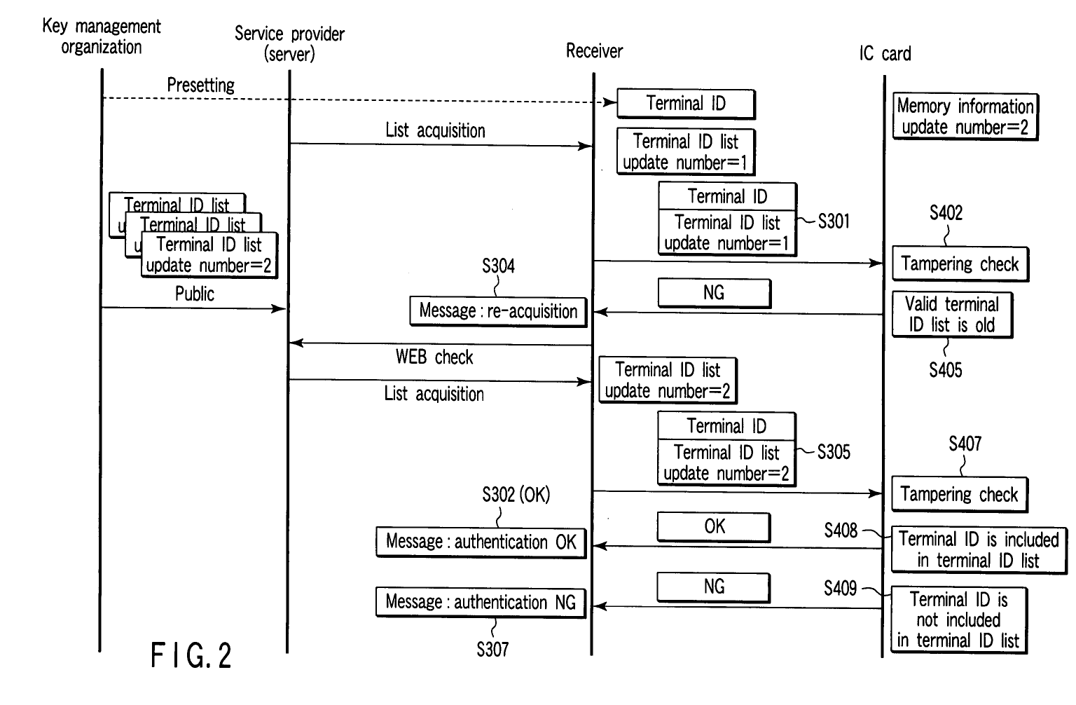

FIG. 2 shows an example of an authentication sequence, which is started when the digital broadcast receiving apparatus 101 is powered on (i.e. when the IC card interface is activated).

The timings of starting the authentication sequence between the digital broadcast receiving apparatus 101 and IC card 115 include: (1) when the digital broadcast receiving apparatus 101 is powered on, (2) when the IC card interface 110 is activated, (3) when an instruction is issued from the IC card 115, (4) when an instruction is issued from the server which is in communication, and (5) when the digital broadcast receiving apparatus 101 is periodically started by the clock function of the digital broadcast receiving apparatus 101.

As has been described above, the memory unit 112 is composed of a RAM and a nonvolatile memory. At least the terminal ID of the receiving apparatus, which is issued from the key management organization, is set in the nonvolatile memory when the digital broadcast receiving apparatus 101 is manufactured. In addition, in the digital broadcast receiving apparatus 101, the memory unit 112 stores a terminal authentication list (terminal ID list) corresponding to this terminal ID, which was acquired from the server of the service provider via the communication process unit 111 by the previous activation of the digital broadcast receiving apparatus 101. If the memory unit 112 in the digital broadcast receiving apparatus 101 does not store the terminal authentication list, the terminal authentication list is acquired from the server of the service provider via the communication process unit 111. The operations of the respective parts will now be described with reference to FIG. 2, etc. Thus, in FIGS. 2, 3 and 4, the steps of the corresponding parts are denoted by like reference numerals.

(Operation of Digital Broadcast Receiving Apparatus 101)

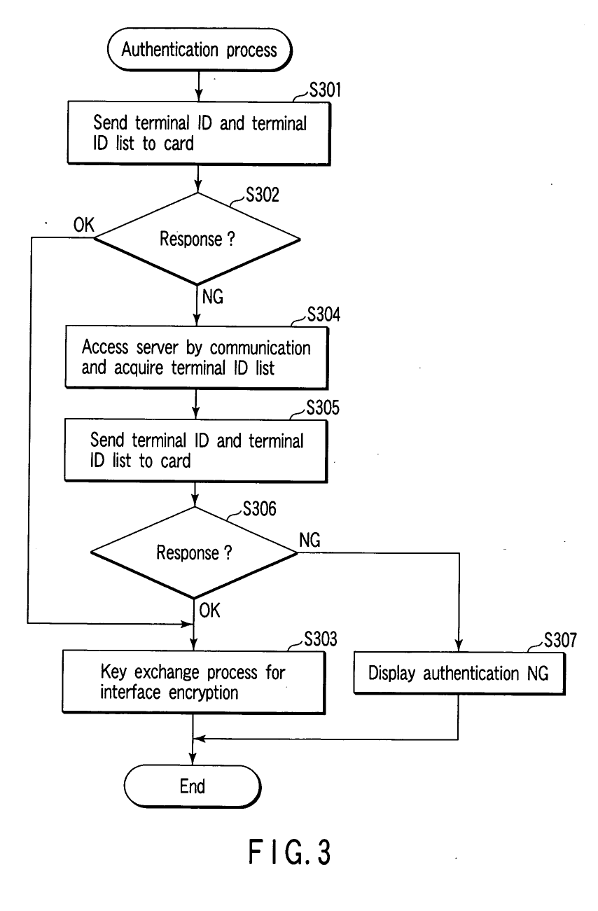

FIG. 3 is a flow chart illustrating the operation of the digital broadcast receiving apparatus 101 at a time when the digital broadcast receiving apparatus 101 is powered on (at a time of activation of the IC card interface).

Step S301: At the time of power-ON (at the time of activation of the interface), the control unit 107 within the digital broadcast receiving apparatus 101 outputs the terminal ID and the terminal authentication list, which are read out of the memory unit 112, to the IC card, and goes to step S302.

Step S302: If a response from the IC card 115 is authentication OK, the normal processing is executed and the control goes to step S303. If the response is authentication NG, the control goes to step S304.

Step S303: In order to encrypt an exchange signal at the interface, a process of exchanging (sharing) an encryption key (common key) between the digital broadcast receiving apparatus 101 and the IC card 115 is executed. This process is executed by a method (e.g. diffe-Helman, etc.) using a challenge response by a common key or using a public key.

Step S304: The control unit 107 acquires a terminal authentication list (terminal ID list) via the communication process unit 111 and stores it in the memory unit 112, and goes to step S305.

Step S305: The control unit 107 outputs the terminal ID and terminal authentication list, which are read out of the memory unit 112, to the IC card, and goes to step S306.

Step S306: If a response from the IC card 115 is authentication OK, the normal process is executed and the control goes to step S203. If the response is authentication NG, the control goes to step S307.

Step S307: The control unit 107 causes the display process unit 106 to generate a display image signal for displaying a message of an authentication error. The generated image signal is output in place of the broadcast program signal (video, audio), or is mixed with the broadcast program signal (video, audio) and the mixed signal is output.

(Operation of the IC Card 115)

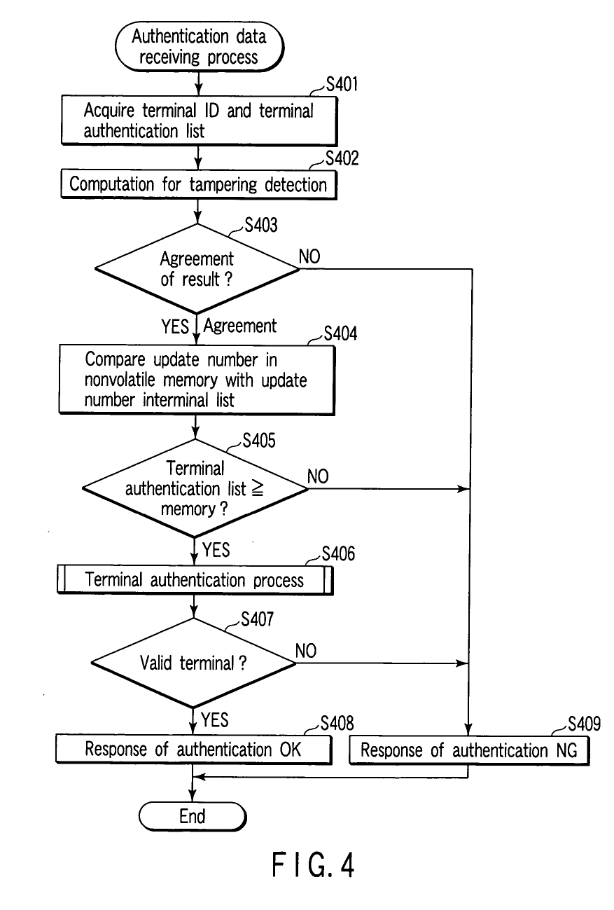

FIG. 4 is a flow chart illustrating the outline of the operation of the IC card 115 at a time when the digital broadcast receiving apparatus 101 is powered on (at a time of activation of the IC card interface).

Step S401: The CPU 119 in the IC card 115 receives the terminal ID and terminal authentication list from the digital broadcast receiving apparatus 101 via the I/F unit 118 of the IC card 115, and goes to step S402.

Step S402: The CPU 119 executes a computation for detecting tampering of the terminal authentication list (or terminal ID), thereby checking the presence/absence of tampering, and goes to step S403. The tampering check method will be described later in detail.

Step S403: If the tampering check result in step S402 indicates the absence of tampering, the CPU 119 goes to step S404. If the tampering check result indicates the presence of tampering, the CPU 119 goes to step S409.

Step S404: The CPU 119 compares an update number of the terminal authentication list, which is stored in the nonvolatile memory 120 in the IC card 115, with an update number within the terminal authentication list that is received from the digital broadcast receiving apparatus 10, and goes to step S405.

Step S405: The CPU 119 determines, based on the comparison result in step S404, whether the update number within the terminal authentication list, which is received from the digital broadcast receiving apparatus 101, is equal to or greater (i.e. an equal update number or a later update number) than the update number of the terminal authentication list, which is stored in the nonvolatile memory 120 in the IC card. If the update number received from the digital broadcast receiving apparatus 101 is equal to or greater than the update number stored in the nonvolatile memory 120, the terminal authentication list with this latest update number is set as an actually adopted terminal authentication list. Then, the CPU 119 goes to step S406. If the update number received from the digital broadcast receiving apparatus 101 is less (older) than the update number stored in the nonvolatile memory 120, the CPU 119 goes to step S409.

Step S406: The CPU 119 executes a terminal authentication process for collating the terminal authentication list, which is actually adopted in step S405, with the terminal ID that is received from the digital broadcast receiving apparatus 101, and goes to step S407.

Step S407: If the check result in step S406 is authentication OK, the CPU 119 goes to step S408. If the check result in step S406 is authentication NG, the CPU 119 goes to step S409.

Step S408: The CPU 119 returns authentication OK as a response to the digital broadcast receiving apparatus 101 via the I/F unit 118.

Step S409: The CPU 119 returns authentication NG as a response to the digital broadcast receiving apparatus 101 via the I/F unit 118.

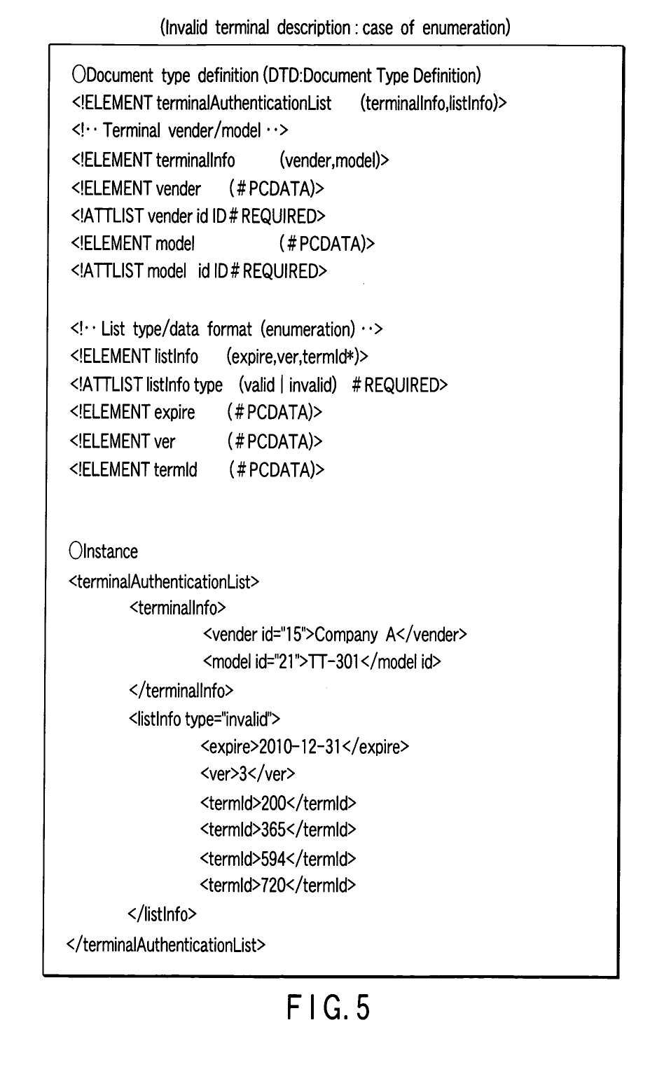

FIG. 5 shows an example of the data structure of the terminal authentication list (terminal ID list) which is of an enumeration type. In this example, the discrimination of the terminal with the valid terminal list/invalid terminal list is set by the attribute type (type of list) of an element “listInfo”. In “Instance”, the case in which invalid terminals are designated is indicated. Terminals ID200, 365, 594 and 720, which are described in “termld” elements, are invalid.

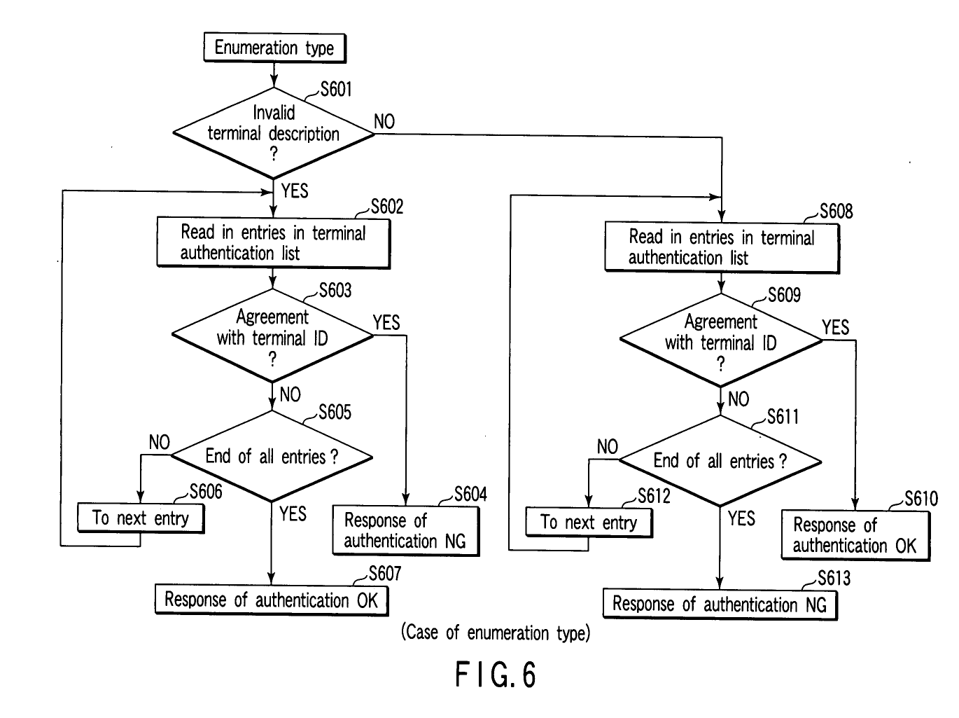

FIG. 6 shows the details of the terminal authentication process in the IC card, which corresponds to step S406 in FIG. 4. In FIG. 6, in step S601, on the basis of the value of the type of the element “listInfo”, it is determined whether the type of list is an invalid terminal list or a valid terminal list. If the terminal authentication list is the invalid terminal list, the control goes to step S602 and the first entry (i.e. data of “termld” element) in the terminal list is read in. In step S603, the terminal ID in the IC card is collated with the terminal ID that is received from the digital broadcast receiving apparatus 101. If the collated terminal IDs agree, the receiving apparatus is determined to be an invalid terminal. In step S604, a response of authentication NG is returned to the digital broadcast receiving apparatus 101.

If the collated terminal IDs do not agree, the control goes to step S605. If all entries in the terminal authentication list have not yet been checked, the read-out point is advanced to the next entry in step S606 and the control returns to step S602. Then, the above process is repeated.

If all entries have been checked in step S605 and all entries do not agree with the terminal ID of the digital broadcast receiving apparatus 101, the digital broadcast receiving apparatus 101 is determined to be a valid terminal. In this case, the control goes to step S607, and a response of authentication OK is sent to the digital broadcast receiving apparatus 101.

If the terminal authentication list is determined to be the valid terminal list in step S601, the control goes to step S608, and the first entry (i.e. data of “termld” element) in the terminal list is similarly read in. In step S609, the terminal ID in the IC card is collated with the terminal ID that is received from the digital broadcast receiving apparatus 101. If the collated terminal IDs agree, the receiving apparatus is determined to be a valid terminal. In step S610, a response of authentication OK is returned to the digital broadcast receiving apparatus 101.

If the collated terminal IDs do not agree (authentication NG), the control goes to step S611. If all entries in the terminal authentication list have not yet been checked, the read-out point is advanced to the next entry in step S612 and the control returns to step S608. Then, the above process is repeated.

If all entries have been checked in step S611 and all entries do not agree with the terminal ID of the digital broadcast receiving apparatus 101, the digital broadcast receiving apparatus 101 is determined to be an invalid terminal. In this case, the control goes to step S613, and a response of authentication NG is sent to the digital broadcast receiving apparatus 101.

The present embodiment relates to the case in which the terminal authentication list of XML description format is acquired and processed on the basis of two-way communication. However, the invention is not limited to these environment and format. For example, the terminal authentication list may be acquired through broadcast, and the data structure may be described in a section format in broadcasting.

In the above-described terminal authentication list, discrimination information as to whether the terminal authentication list is a list of valid terminals or a list of invalid terminals is sent. In addition, object terminal IDs are enumerated. On the IC card side, it is determined whether the ID of the receiving apparatus 101 is present in the terminal list or not. In the IC card, a determination result of authentication OK/authentication NG is output on the basis of this determination result and on the basis of whether the terminal list is the valid terminal list or invalid terminal list.

As described above, the discrimination information indicating the valid terminal list or the invalid terminal list is provided in the terminal authentication list. Thus, if the data amount of the valid terminal list increases, the invalid terminal list with a less data amount may be sent. If the data amount of the invalid terminal list increases, the valid terminal list with a less data amount may be sent. Thereby, the data processing load on the IC card can be reduced. The same advantageous effects can be obtained with embodiments to be described below.

### Second Embodiment

As regards a second embodiment of the invention, a description is given of the data structure of the terminal authentication list of a range designation type, and the associated process. In the second embodiment, object terminal IDs are not enumerated in the valid terminal list or invalid terminal list. Instead, the range of object terminal IDs is described.

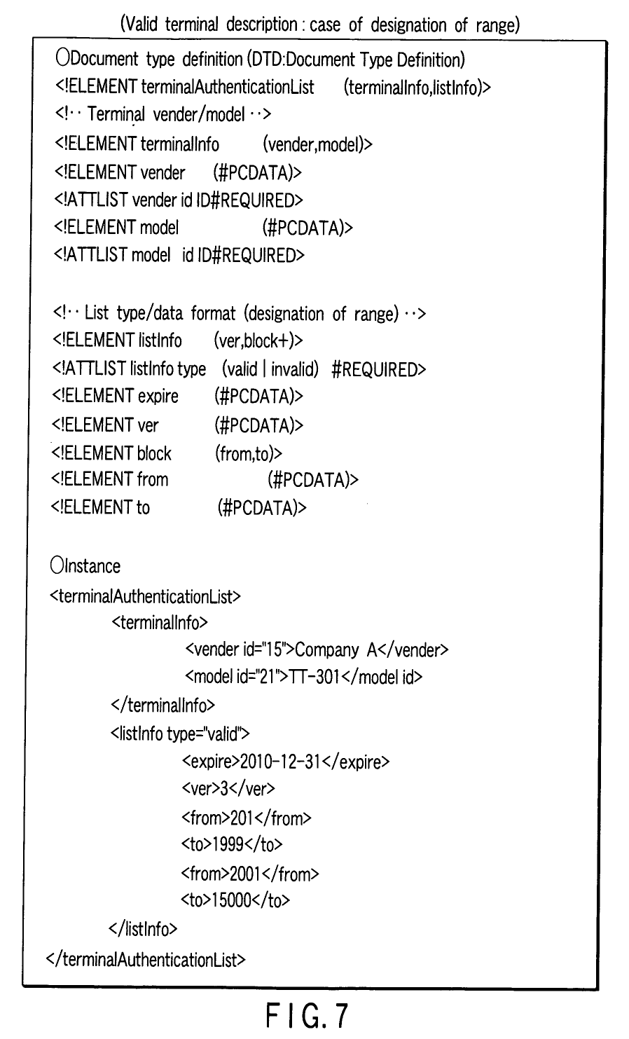

FIG. 7 shows an example of the terminal authentication list in this case. In this example, too, the discrimination between valid terminals and invalid terminals is set by the attribute “type” (type of list) of the element “listInfo”. In “Instance”, the case in which valid terminals are designated is indicated. In this “Instance”, terminals, which fall within the range of terminal IDs designated from <from> element to <to> element, that is, 201 to 1999 and 2001 to 15000, are valid terminals.

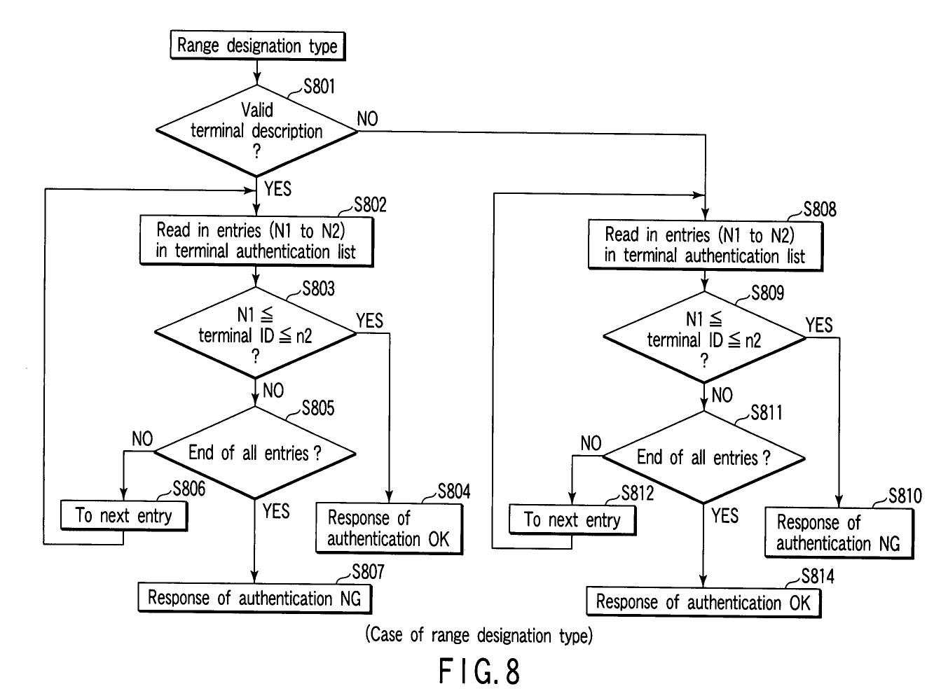

Like FIG. 6 illustrating the first embodiment, FIG. 8 illustrates the procedures of the terminal authentication process in the IC card. In step S801, on the basis of the value of the attribute “type” of the element “listInfo”, it is determined whether the type of list is an invalid terminal list or a valid terminal list. If the terminal authentication list is the valid terminal list, the control goes to step S802 and the first entry (i.e. data N1 and N2 of <from> element and <to> element) in the terminal list is read in. In step S803, the terminal ID in the IC card is collated with the terminal ID that is received from the digital broadcast receiving apparatus 101. If the collated terminal ID falls within the range that is designated by entries, the digital broadcast receiving apparatus 101 is determined to be a valid terminal. In step S804, a response of authentication OK is returned to the digital broadcast receiving apparatus 101.

If the collated terminal ID does not fall within the range, the control goes to step S805. If all entries in the terminal authentication list have not yet been checked, the read-out point is advanced to the next entry in step S806 and the control returns to step S802. Then, the above process is repeated.

If all entries have been checked in step S805 and all entries do not fall within the range, the digital broadcast receiving apparatus 101 is determined to be an invalid terminal. In this case, the control goes to step S807, and a response of authentication NG is sent to the digital broadcast receiving apparatus 101.

If the terminal authentication list is determined to be the invalid terminal list in step S801, the control goes to step S808, and the first entry (i.e. data N1 and N2 of <from> element and <to> element) in the terminal list is similarly read in. In step S809, the terminal ID in the IC card is collated with the terminal ID that is received from the digital broadcast receiving apparatus 101. If the collated terminal ID falls within the range that is designated by entries, the digital broadcast receiving apparatus 101 is determined to be an invalid terminal. In step S810, a response of authentication NG is returned to the digital broadcast receiving apparatus 101. If the collated terminal ID does not fall within the range, the control goes to step S811. If all entries in the terminal authentication list have not yet been checked, the read-out point is advanced to the next entry in step S812 and the control returns to step S808. Then, the above process is repeated.

If all entries have been checked in step S811 and all entries do not fall within the range, the digital broadcast receiving apparatus 101 is determined to be a valid terminal. In this case, the control goes to step S813, and a response of authentication OK is sent to the digital broadcast receiving apparatus 101.

The present embodiment also relates to the case in which the terminal authentication list of XML description format is acquired and processed on the basis of two-way communication. However, the invention is not limited to these environment and format. For example, the terminal authentication list may be acquired through broadcast, and the data structure may be described in a section format in broadcasting.

### Third Embodiment

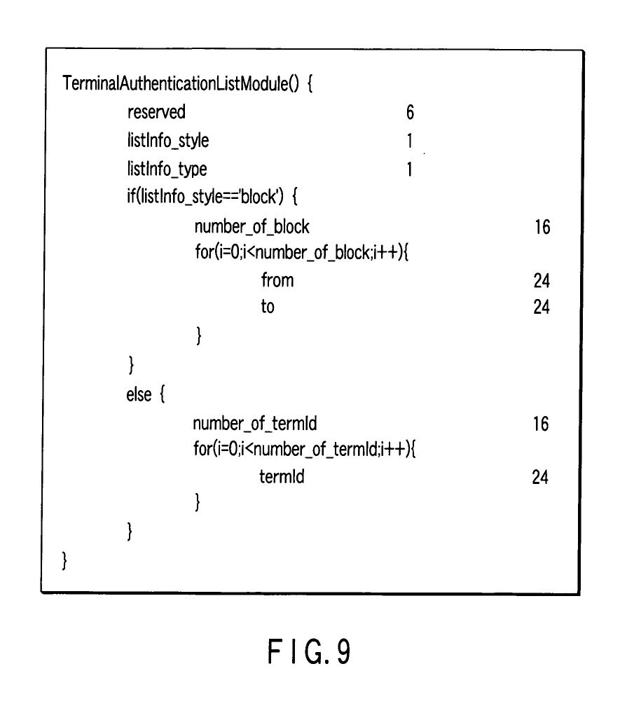

As regards a third embodiment of the invention, FIG. 9 shows a data structure in a case where the terminal authentication list is transmitted through broadcast. In this example, the transmission is realized by a download method using a data carousel transmission scheme as in ARIB STD-B21. Terminal discrimination information (maker ID, model ID, object version, etc.) is transmitted using “compatibilityDescriptor” of DII (DownloadInfoIndication). The receiving side checks the terminal discrimination information and extracts transmission information of the terminal authentication list that is the object. Further, the terminal authentication list body, as shown in FIG. 9, is transmitted by a designated DDB (DownloadDataBlock), and is received by the receiver.

As regards the details of the terminal authentication process in the IC card in this case, the process of FIG. 8 of the second embodiment and the process of FIG. 6 of the first embodiment, for example, are applied, depending on whether the value in the “listInfo_style” field is a block (range designation type) or not (list type).

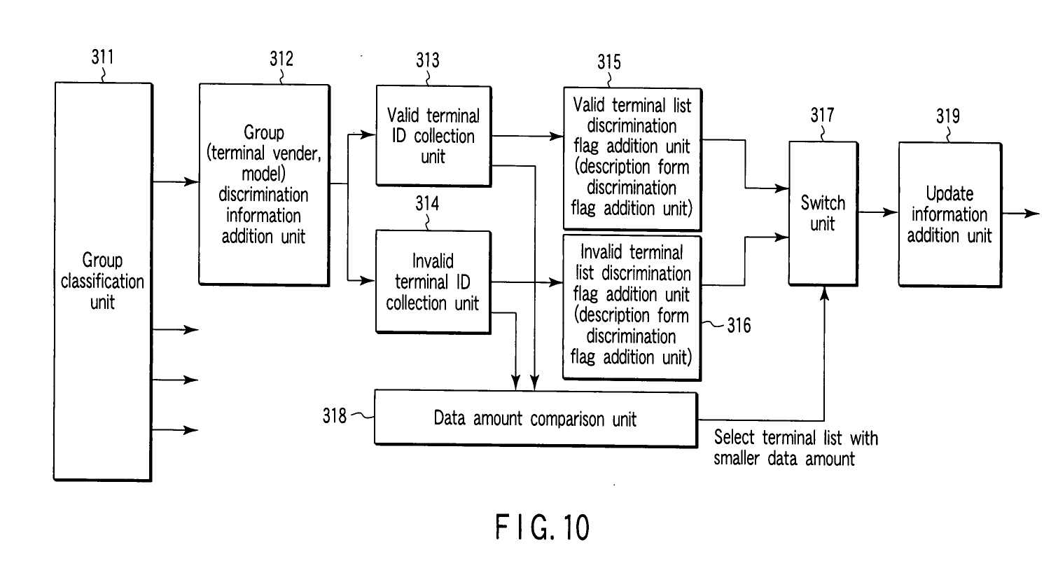

FIG. 10 is a block diagram showing a terminal authentication list generating unit, for example, in the server. The terminal IDs, which are the objects, are classified into groups by a group classification unit 311 according to, for example, terminal venders or model types. Specifically, terminal authentication lists are generated for the respective groups, and the data amount of each individual terminal authentication list is reduced. A group information addition unit 312 adds an identification number of a group, into which terminal IDs are grouped, to these terminal IDs. Subsequently, a valid terminal ID collection unit 313 collects IDs of valid terminals, and generates a valid terminal list. An invalid terminal ID collection unit 314 collects IDs of invalid terminals, and generates an invalid terminal list. A discrimination flag addition unit 315 adds a valid terminal list discrimination flag to the valid terminal list, and a discrimination flag addition unit 316 adds an invalid terminal list discrimination flag to the invalid terminal list. The valid terminal list and invalid terminal list, which are processed by the discrimination flag addition units 315 and 316, are input to a switching unit 317, and one of the terminal lists is selected and output. An update information addition unit 319 adds an update date/time or an incremented update number to the selected and output terminal list, and the terminal list is set in a state in which it is to be transmitted.

The switching unit 317 compares the data amount of the invalid terminal list and that of the valid terminal list, and selects and outputs one of them, which has a smaller data amount. Thereby, the amount of data, which is processed in the IC card, can be minimized.

For example, in the discrimination flag addition unit 315, 316, it is possible to add discrimination information indicative of which of the types shown in FIG. 5, FIG. 7 and FIG. 9 corresponds to the terminal list. In this case, the IC card stores a data processing program which corresponds to the respective type discrimination steps and the respective types.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An IC card comprising:
a data receiving unit which receives a terminal authentication list and a receiving apparatus ID from a memory unit of a receiving apparatus;
a first determination unit which obtains a first determination result by determining, with reference to first discrimination information contained in the terminal authentication list, whether the terminal authentication list is an invalid terminal list or a valid terminal list; a second determination unit which obtains a second determination result by determining whether the receiving apparatus ID is included in the terminal authentication list; and
a reply unit which returns to the receiving apparatus a response signal indicative of whether the receiving apparatus is the valid terminal or not, in accordance with contents of the first determination result and the second determination result.

2. The IC card according to claim 1, wherein the reply unit returns a response indicating that the receiving apparatus is the invalid terminal, when the first determination result indicates the “invalid terminal list” and the second determination result indicates that the receiving apparatus ID is included in the terminal authentication list, the reply unit returns a response indicating that the receiving apparatus is the valid terminal, when the first determination result indicates the “valid terminal list” and the second determination result indicates that the receiving apparatus ID is included in the terminal authentication list, the reply unit returns a response indicating that the receiving apparatus is the valid terminal, when the first determination result indicates the “invalid terminal list” and the second determination result indicates that the receiving apparatus ID is not included in the terminal authentication list, and the reply unit returns a response indicating that the receiving apparatus is the invalid terminal, when the first determination result indicates the “valid terminal list” and the second determination result indicates that the receiving apparatus ID is not included in the terminal authentication list.

3. The IC card according to claim 1, wherein valid or invalid terminal IDs are enumerated in the terminal authentication list, and the second determination unit determines, in a round-robin fashion, whether the receiving apparatus ID is included in the terminal authentication list.

4. The IC card according to claim 1, wherein valid or invalid terminal IDs are specified in the terminal authentication list by a designated range, and the second determination unit determines, by a comparison process, whether the receiving apparatus ID is included in the designated range.

5. A broadcast receiving apparatus comprising:
a receiving unit which receives broadcast waves;
a signal processing unit which descrambles and decodes a reception output from the receiving unit, thereby producing decoded video and audio;
a communication processing unit which is connected to an external network;
a group discrimination information determination unit which determines group discrimination information of a terminal authentication list, which is acquired from the receiving unit that receives the broadcast waves or from a server via the communication processing unit;
a list receiving unit which stores the terminal authentication list in a memory unit when the group discrimination information indicates a group which specifies the own broadcast receiving apparatus;
an interface for connection to an IC card in which viewing/listening contract information is set;
an authentication start unit which outputs the terminal authentication list and a receiving apparatus ID to the interface, thereby to start authentication, at least when the interface is activated; and
an authentication result display processing unit which outputs, when a response indicative of failure of authentication is sent from the IC card as a result of a check between the terminal authentication list and the receiving apparatus ID, a result of the response to a display process unit.

6. The broadcast receiving apparatus according to claim 5, wherein the authentication start unit starts authentication when power is turned on, when the IC card is inserted in the interface, when an instruction is issued from the server via the communication processing unit, or when periodical driving is executed by a clock function.

7. A terminal authentication list generating apparatus comprising:
a group classification unit which classifies terminals into groups;
a group discrimination information addition unit which adds group discrimination information to a terminal list of the terminals which are classified into a predetermined group;
a first terminal ID collection unit and a second terminal ID collection unit which collect terminal IDs of the terminals of the predetermined group and generate, as the terminal list, a terminal list of valid terminals and a terminal list of invalid terminals, respectively;
a first discrimination information addition unit and a second discrimination information addition unit which add discrimination information of “valid” and discrimination information of “invalid” to the terminal list of valid terminals and the terminal list of invalid terminals, which are generated by the first and second terminal ID collection units, respectively; and
a switch unit which selects one of the terminal list of valid terminals with the discrimination information of “valid” and the terminal list of invalid terminals with the discrimination information of “invalid”, which has a smaller data amount, as a terminal list to be transmitted.

8. The terminal authentication list generating apparatus according to claim 7, further comprising an addition unit which adds, to the terminal list of the valid terminals and the terminal list of the invalid terminals, discrimination information which discriminates whether terminal IDs are specified by enumeration or by a designated range.

9. The terminal authentication list generating apparatus according to claim 7, further comprising an update information addition unit which adds, to the terminal list of the valid terminals and the terminal list of the invalid terminals, update information for discrimination of latest content.
